(19) United States
(12) Patent Application Publication
(10) Pub. No.: US 2013/0078417 A1
(43) Pub. Date: Mar. 28, 2013

(54) SEMIFINISHED PRODUCT FOR THE PRODUCTION OF FIBRE COMPOSITE COMPONENTS BASED ON STABLE POLYURETHANE COMPOSITIONS

(71) Applicant: Friedrich Georg Schmidt, Haltern am See (DE)

(72) Inventor: Friedrich Georg Schmidt, Haltern am See (DE)

(73) Assignee: Evonik Degussa GmbH, Essen (DE)

(21) Appl. No.: 13/700,734

(22) PCT Filed: May 18, 2011
(86) PCT No.: PCT/EP2011/058055

§ 371 Date: Nov. 29, 2012

(30) Foreign Application Priority Data
Jun. 17, 2010 (DE) 10 2010 030 233.3

(51) Int. Cl. B32B 3/12; B32B 27/40; B32B 3/28

(52) U.S. Cl. CPC B32B 3/12; B32B 3/28; B32B 27/40
USPC 428/116; 156/242

(57) ABSTRACT

The invention relates to a semifinished product for the production of fibre composite components, comprising at least two walls of fibre-filled matrix material, which are angled in a meandering manner and are thermally joined to one another to form a symmetrical core structure. The invention addresses the problem of providing a semifinished product which is suitable as a core structure for a fibre composite component in sheet form that has better draping qualities as a result of the not yet cured matrix, but at the same time is sufficiently stable in terms of its shape and composition that it can be easily handled. This problem is solved by using as the matrix material a polyurethane composition which contains as a binder a polymer having functional groups that are reactive with respect isocyanates and contains as a hardener diisocyanate or polyisocyanate that is blocked internally and/or by blocking agents.

The invention relates to a semifinished product for the production of fiber-composite components, comprising at least two walls which have angled undulations and are made of fiber-filled matrix material, and which been joined thermally to one another in a manner which forms a symmetrical core structure. The invention further relates to a process for producing this type of semifinished product, to a process for the production of fiber-composite components from this type of semifinished product, and to a fiber-composite component produced from this type of semifinished product.

A fiber-composite component is a part intended for technical equipment and produced from a fiber-composite material. Because fiber-composite components have low density and high stiffness and strength, they are widely used in aerospace, in vehicle construction, and in mechanical engineering and plant engineering, and also in sports equipment. Fiber-composite materials are inhomogeneous materials composed of a matrix material made of plastic and, incorporated therein, natural or synthetic, organic or inorganic fibers. The fibers serve to transmit forces within the fiber-composite component, and the matrix conducts the external forces into the fibers and protects these from damaging environmental effects.

A particular feature of the mode of construction of fiber composites is that fiber-composite material and fiber-composite component are produced simultaneously, namely by virtue of the inseparable bonding of fiber and matrix. Traditional materials, such as steel or wood, exist already prior to the component molded therefrom.

However, fiber-composite components are composed of semifinished products: geometrically determinate moldings which are handleable and which comprise fiber and matrix material of the subsequent composite material, but still without any firm coherence between fiber and matrix. Said coherence is produced only with hardening of the matrix through a chemical reaction. Accordingly, in the production of fiber-composite components, semifinished products which are still drapable or trimmable are sometimes arranged in relation to one another and then hardened to give the composite material.

Fiber-composite components in the form of sheets mostly comprise two separate outer layers which extend in the plane of the sheet and which are parallel to one another, and between which a hexagonal honeycomb structure has been laminated, as distortion-resistant core. The hexagonal honeycomb structure here is in turn composed of a plurality of fiber-containing walls arranged orthogonally with respect to the outer layers.

DE 38 38 153 C2 describes a process for producing a hexagonal honeycomb structure suitable as core for a fiber-composite component. Here, a thermoplastic matrix material with fibers is molded to give a wall which, in a following forming-process step, obtains a shape with 120°-angled undulations. A plurality of said walls are then oriented with respect to one another in such a way that the adjacent undulations form hexagonal honeycombs. Because the thermoplastic material is fusible, it is possible to join the walls thermally at the sites where the adjacent undulations meet.

This honeycomb structure produced from thermoplastic material has a fundamental property of high stiffness even before the fiber-composite material is finished, since the thermoplastic matrix has already hardened. Strictly speaking, therefore, this is not a semifinished product in the sense described above. A disadvantage of this honeycomb structure is its poor drapability during production of the composite component.

In view of this prior art, it is an object of the invention to provide a semifinished product which is suitable as core structure for a fiber-composite component in the form of a sheet and which has better drapability because the matrix has not yet hardened, but which at the same time is easy to handle because it has sufficient dimensional stability and storage stability.

Said object is achieved in that a polyurethane composition which comprises
a) as binder, a polymer having functional groups reactive toward isocyanates,
b) and, as hardener, di- or polyisocyanate blocked internally and/or blocked with blocking agents
   is used as matrix material.

The invention therefore provides a semifinished product for the production of fiber-composite components, comprising at least two walls which have angled undulations and are made of fiber-filled matrix material, and which have been joined thermally to one another in a manner which forms a symmetrical core structure, characterized in that the matrix material involves a polyurethane composition which comprises
a) as binder, a polymer having functional groups reactive toward isocyanates,
b) and, as hardener, di- or polyisocyanate blocked internally and/or blocked with blocking agents.

In the invention, said polyurethane composition has not yet hardened. For this purpose, the blocking of the hardener has to be removed by introducing heat, in order that the crosslinking reaction can begin.

The invention is based inter alia on the surprising discovery that fiber-filled matrix material of this polyurethane composition can be thermally joined at a temperature which is below the temperature needed to remove the blocking effect. This means that walls made of fiber-filled, unhardened matrix material can be “provisionally fixed” to one another at certain points in a plastics-welded process, in order to produce, from the walls, a symmetrical core structure, for example a hexagonal honeycomb. Since inhibition of the crosslinking reaction continues, despite thermal joining, the semifinished product of the invention does not cure, and it therefore retains a certain flexibility and drapability, and can therefore be processed advantageously to give a fiber-composite component. The hardening of the semifinished product then takes place on exposure of a large area to heat at a higher temperature level. The crosslinking reaction then also transcends the wall boundaries, and the crosslinked fiber-composite component therefore has much greater strength at the joints than the uncrosslinked semifinished product that has merely welded.

In one embodiment of the invention, the semifinished product is provided with at least one outer layer applied to the core structure, where core structure and outer layer have been joined coherently. Coherently in particular means adhesion or a thermal joining process, for example soldering or welding. Adhesion is useful when the outer layer is composed of a material other than the matrix material, for example of metal. As long as the matrix material of the core bonded to the outer layer has not hardened, the stiffening effect of the core is still relatively small.

In one particularly preferred embodiment of the invention, the outer layer is composed of a matrix material such as that of the walls, and the core structure is likewise joined thermally to the outer layer of the semifinished product. The particular advantage of this embodiment is mainly that, on hardening of the polyurethane composition, a crosslinking process transcends the meeting points of core and outer layer, and the fiber-composite component therefore obtains particularly high strength. However, the unhardened outer layer is still flexible.

The production of a semifinished product of the invention proceeds as follows:
a) provision of a polyurethane composition comprising, as binder, a polymer having functional groups reactive toward isocyanates, and, as hardener, of di- or polyisocyanate blocked internally and/or blocked with blocking agents,
b) provision of fibers,
c) mixing of the polyurethane composition and of the fibers to give a molding composition,
d) molding of the molding composition to give a flat wall,
e) subjecting the wall to a forming process in order to give it a shape which has angled undulations,
f) orientation of the wall which has angled undulations, in relation to another wall which has angled undulations,
g) thermal joining at least of the two walls to give a symmetrical core structure.

A process of this type is likewise provided by the invention.

The polyurethane composition can be provided dry in powder form or wet—dissolved in a solvent.

The mixing of the dry powder with the fibers can by way of example take place in a manner known per se in a (screw-based) extruder, and the molding of the wall can take place through extrusion of the molding composition through an appropriately shaped die. The mixing of fiber and matrix in the extruder will be possible only with short fiber lengths.

If the intention is to process greater fiber lengths or to achieve unidirectional fiber orientation, the mixing/molding process can take place in a manner known per se in a pultrusion process. Here, a wet polymer composition is processed.

The fibers can be present in sheet-like textile structures (e.g. woven fabrics, braided fabrics, knitted fabrics, laid scrims, non-woven), and can be saturated in a manner known per se with the polyurethane composition dissolved in the solvent. The solvent is removed by evaporation from the saturated sheet-like structure, in such a way that the wall made of fiber-filled matrix material remains.

It is preferable that the manufacturing process is extended by steps for the application of outer layer to the core structure. A semifinished product with outer layers is obtained. The application of the outer layer on the core structure takes place at temperatures as for the thermal joining process.

The thermal joining of the walls to the core or of the outer layer(s) on the core preferably takes place at a temperature which is below the temperature which is below the hardening temperature of the polyurethane composition, in order that there is still no polymerization of the matrix in the region of the join, and the semifinished product remains conformable.

The hardening of the semifinished product to give the finished fiber-composite component then takes place at a temperature above that for the thermal joining process. A process of the invention for the production of a fiber-composite component therefore comprises the steps of provision of a semifinished product produced in the invention and hardening of the polyurethane composition at a temperature above the temperature for the thermal joining process.

The invention therefore also provides a process for producing a fiber-composite component with said steps, and also a fiber-composite component produced from a semifinished product of the invention, in particular by said processes.

The use of an inhibited polyurethane composition as matrix material is an essential feature of the present invention, and this composition comprises
a) as binder, a polymer having functional groups reactive toward isocyanates,
b) and, as hardener, di- or polyisocyanate blocked internally and/or blocked with blocking agents.

In principle, all polyurethane compositions that are reactive and storage-stable at room temperature are suitable as matrix materials. Particularly suitable polyurethane compositions are composed of mixtures of, as binder, a polymer having functional groups—reactive toward NCO groups—and of, as hardener, di- or polyisocyanates which have been temporarily deactivated, i.e. blocked internally and/or blocked with blocking agents.

Suitable functional groups of the polymers used as binder are hydroxy groups, amino groups and thiol groups, where these react with the free isocyanate groups in an addition reaction and thus crosslink and harden the polyurethane composition. The binder components must have solid-resin character (glass transition temperature higher than room temperature). Binders that can be used are polyesters, polyethers, polyacrylates, polycarbonates and polyurethanes having an OH number of from 20 to 500 mg KOH/gram and having an average molar mass of from 250 to 6000 g/mol. Particular preference is given to hydroxylated polyesters or polyacrylates having an OH number of from 20 to 150 mg KOH/gram and having an average molar mass of from 500 to 6000 g/mol. It is also possible, of course, to use mixtures of polymers of this type. The amount of the polymers having functional groups is selected in such a way that for each functional group of the binder component there are from 0.6 to 2 NCO equivalents or from 0.3 to 1.0 uretdione groups of the hardener component.

Di- and polyisocyanates blocked with blocking agents or blocked internally (uretdione) can be used as hardener component.

The di- and polyisocyanates used in the invention can be composed of any desired aromatic, aliphatic, cycloaliphatic, and/or (cyclo)aliphatic di- and/or polyisocyanates.

Suitable aromatic di- or polyisocyanates are in principle any of the known aromatic compounds. The following are particularly suitable: phenyene 1,3- and 1,4-diisocyanate, naphthylene 1,5-diisocyanate, tolidine diisocyanate, tolylene 2,6-diisocyanate, tolylene 2,4-diisocyanate (2,4-TDI), diphenylmethane 2,4′-diisocyanate (2,4′-MDI), diphenylmethane 4,4′-diisocyanate, the mixtures of monomeric diphenylmethane diisocyanates (MDI) and of oligomeric diphenylmethane diisocyanates (polymer MDI), xylylene diisocyanate, tetramethylxylylene diisocyanate, and triisocyanatotoluene.

Suitable aliphatic di- or polyisocyanates advantageously have from 3 to 16 carbon atoms, preferably from 4 to 12 carbon atoms, in the linear or branched alkylene moiety, and suitable cycloaliphatic or (cyclo)aliphatic diisocyanates advantageously have from 4 to 18 carbon atoms, preferably from 6 to 15 carbon atoms, in the cycloalkylene moiety. The person skilled in the art is well aware that the expression (cyclo)aliphatic diisocyanates implies NCO groups bonded to both cyclic and aliphatic systems, as is the case by way of example in isophorone diisocyanate. In contrast, the expression cycloaliphatic diisocyanates implies diisocyanates which have only NCO groups bonded directly at the cycloaliphatic ring, an example being H₁₂MDI.

Examples are cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, for example 4-isocyanatomethyl-1,8-octane diisocyanate (TIN), decane diisocyanate, decane triisocyanate, undecane diisocyanate and undecane triisocyanate, dodecane diisocyanate and dodecane triisocyanates.

Preference is given to isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), and norbornane diisocyanate (NBDI). It is very particularly preferable to use IPDI, HDI, TMDI, and H₁₂MDI, and it is also possible here to use the isocyanurates.

The following are equally suitable: 4-methylcyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, methylenebis(cyclohexyl 2,4′-diisocyanate), and 1,4-diisocyanato-4-methylpentane.

It is also possible, of course, to use mixtures of the di- and polyisocyanates.

It is moreover preferable to use oligo- or polyisocyanates which can be produced from the di- or polyisocyanates mentioned or from mixtures of these through linkage by means of urethane structures, allophanate structures, urea structures, biuret structures, uretdione structures, amide structures, isocyanurate structures, carbodiimide structures, uretonimine structures, oxadiazinetrione structures, or iminooxadiazinedione structures. Isocyanurates, in particular derived from IPDI and HDI, are particularly suitable.

The polyisocyanates used in the invention have been blocked. External blocking agents can be used for this purpose, examples being ethyl acetoacetate, diisopropylamine, methyl ethyl ketoxim, diethyl malonate, ε-caprolactam, 1,2,4-triazole, phenol and substituted phenols, and 3,5-dimethylpyrazole.

The hardener components preferably used are IPDI adducts, which comprise isocyanurate groupings and ε-caprolactam-blocked isocyanate structures.

Internal blocking is also possible, and this is preferably used. The internal blocking takes place by way of formation of a dimer by way of uretdione structures which, at elevated temperature, revert by cleavage to the isocyanate structures initially present, and thus initiate the crosslinking with the binder.

The reactive polyurethane compositions can optionally comprise additional catalysts. These involve organometallic catalysts, e.g. dibutyltin dilaurate (DBTL), tin octoate, bismuth neodecanoate, or else tertiary amines, such as 1,4—diazabicyclo[2.2.2.] octane, in amounts of from 0.001 to 1% by weight. These reactive polyurethane compositions used in the invention are usually hardened under standard conditions, e.g. with DBTL catalysis, beginning at 160° C., usually beginning at about 180° C., and termed.

The additives conventional in powder-coating technology, for example flow aids, e.g. polysilicones or acrylates, light stabilizers, e.g. sterically hindered amines, or the other auxiliaries described by way of example in EP 669 353 can be added in a total amount of from 0.05 to 5% by weight to produce the reactive polyurethane compositions. Fillers and pigments, e.g. titanium dioxide, can be added in an amount of up to 30% by weight of the entire composition.

For the purposes of this invention, reactive (variant I) means that the reactive polyurethane compositions used in the invention harden as described above at temperatures starting at 160° C., where this specifically depends on the nature of the fiber.

The reactive polyurethane compositions used in the invention are hardened under standard conditions, e.g. with DBTL catalysis, beginning at 160° C., usually beginning at about 180° C. The hardening time for the polyurethane composition used in the invention is generally within from 5 to 60 minutes.

The present invention preferably uses a matrix material made of a polyurethane composition comprising reactive uretdione groups, in essence comprising
a) at least one hardener comprising uretdione groups and based on polyadducts derived from aliphatic (cyclo)aliphatic, or cycloaliphatic polyisocyanates comprising uretdione groups and from hydroxylated compounds, where the hardener is solid below 40° C. and liquid above 125° C. and has less than 5% by weight NCO content and 3 to 25% by weight uretdione content,
b) at least one hydroxylated polymer which is solid below 40° C. and liquid above 125° C. and has an OH number from 20 to 200 mg KOH/gram,
c) optionally at least one catalyst, and
d) optionally auxiliaries and additives known from polyurethane chemistry,
   in such a way that the ratio present of the two components, hardener and binder, is such that there is from 0.3 to 1, preferably from 0.45 to 0.55, uretdione group of the hardener component for each hydroxy group of the binder component. The latter corresponds to an NCO/OH ratio of from 0.9 to 1.1:1.

Polyisocyanates comprising uretdione groups are well known and are described by way of example in U.S. Pat. No. 4,476,054, U.S. Pat. No. 4,912,210, U.S. Pat. No. 4,929,724, and EP 417 603. J. Prakt. Chem. 336 (1994) 185-200 provides a comprehensive overview of industrially relevant processes for dimerizing isocyanates to give uretdiones. The reaction of isocyanates to give uretdiones generally takes place in the presence of soluble dimerization catalysts, e.g. dialkylaminopyridines, trialkylphosphines, phosphorous triamides, or imidazoles. The reaction—carried out optionally in solvents, but preferably in the absence of solvents—is terminated by adding catalyst poisons when a desired conversion is reached. Excess monomeric isocyanate is then removed by short-path evaporation. If the catalyst is sufficiently volatile, the reaction mixture can be freed from the catalyst during the course of monomer removal. In this case, the addition of catalyst poisons can be omitted. In principle, a wide range of isocyanates is suitable for producing polyisocyanates comprising uretdione groups. The abovementioned di- and polyisocyanates can be used. However, preference is given to di- and polyisocyanates derived from any desired aliphatic, cycloaliphatic, and/or (cyclo)aliphatic di- and/or polyisocyanates. The invention uses isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), or norbornane diisocyanate (NBDI). It is very particularly preferable to use IPDI, HDI, TMDI, and H₁₂MDI, and the isocyanurates can also be used here.

For the matrix material, it is very particularly preferable to use IPDI and HDI. The reaction of these polyisocyanates comprising uretdione groups to give hardeners containing uretdione groups includes the reaction of the free NCO groups with hydroxylated monomers or polymers, e.g. polyesters, polythioethers, polyethers, polycaprolactams, polyepoxides, polyesteramides, polyurethanes or low-molecular-weight di-, tri- and/or tetraalcohols as chain extenders and optionally monoamines and/or monoalcohols as chain terminators, and has been frequently described (EP 669 353, EP 669 354, DE 30 30 572, EP 639 598 or EP 803 524).

The free NCO content of preferred hardeners having uretdione groups is less than 5% by weight, and the content of uretdione groups in said hardeners is from 3 to 25% by weight, preferably from 6 to 18% by weight (calculated as C₂N₂O₂, molecular weight 84). Preference is given to polyesters and monomeric dialcohols. The hardeners can also have, other than the uretdione groups, isocyanurate structures, biuret structures, allophanate structures, urethane structures, and/or urea structures.

Among the hydroxylated binder polymers, it is preferable to use polyesters, polyethers, polyacrylates, polyurethanes, and/or polycarbonates having an OH number of from 20 to 200 in mg KOH/gram. It is particularly preferable to use polyesters having an OH number of from 30 to 150, and an average molar mass of from 500 to 6000 g/mol, where these are solid below 40° C. and liquid above 125° C. Examples of binders of this type have been described in EP 669 354 and EP 254 152. It is also possible, of course, to use mixtures of polymers of this type. The amount of the hydroxylated polymers is selected in such a way that there is from 0.3 to 1 uretdione group of the hardener component, preferably from 0.45 to 0.55, for every hydroxy group of the binder component.

The reactive polyurethane compositions of the invention can optionally comprise additional catalysts. These involve organometallic catalysts, e.g. dibutyltin dilaurate, zinc octoate, bismuth neodecanoate, or else tertiary amines such as 1,4-diazabicyclo[2.2.2.]octane, in amounts of from 0.001 to 1% by weight. These reactive polyurethane compositions used in the invention are usually hardened under standard conditions, e.g. with DBTL catalysis, beginning at 160° C., usually beginning at about 180° C., and termed variant I.

The additives conventional in powder-coating technology, for example flow aids, e.g. polysilicones or acrylates, light stabilizers, e.g. sterically hindered amines, or the other auxiliaries described by way of example in EP 669 353 can be added in a total amount of from 0.05 to 5% by weight to produce the reactive polyurethane compositions of the invention. Fillers and pigments, e.g. titanium dioxide, can be added in an amount of up to 30% by weight of the entire composition.

The reactive polyurethane compositions used in the invention are hardened under standard conditions, e.g. with DBTL catalysis, starting at 160° C., usually starting at about 180° C. The reactive polyurethane compositions used in the invention provide very good flow and therefore good impregnation capability, and, in the hardened condition, excellent chemicals resistance. When aliphatic crosslinking agents (e.g. IPDI or H₁₂MDI) are used, good weathering resistance is also achieved.

It is particularly preferable in the invention to use a matrix material made of at least one highly reactive polyurethane composition comprising uretdione groups, in essence comprising
a) at least one hardener comprising uretdione groups and
b) optionally at least one polymer having functional groups reactive toward NCO groups;
c) from 0.1 to 5% by weight of at least one catalyst selected from quaternary ammonium salts and/or from quaternary phosphonium salts with halogens, hydroxides, alcoholates, or organic or inorganic acid anions as counterion; and
d) from 0.1 to 5% by weight of at least one cocatalyst, selected from
   d1) at least one epoxide and/or
   d2) at least one metal acetylacetonate and/or quaternary ammonium acetylacetonate and/or quaternary phosphonium acetylacetonate;
e) optionally auxiliaries and additives known from polyurethane chemistry.

Very particularly, a matrix material used derives from at least one highly reactive pulverulent polyurethane composition comprising uretdione groups, as matrix material, in essence comprising
a) at least one hardener comprising uretdione groups and based on polyadducts derived from aliphatic (cyclo)aliphatic, or cycloaliphatic polyisocyanates comprising uretdione groups and from hydroxylated compounds, where the hardener is solid below 40° C. and liquid above 125° C. and has less than 5% by weight NCO content and 3 to 25% by weight uretdione content,
b) at least one hydroxylated polymer which is solid below 40° C. and liquid above 125° C. and has an OH number from 20 to 200 mg KOH/gram;
c) from 0.1 to 5% by weight of at least one catalyst selected from quaternary ammonium salts and/or from quaternary phosphonium salts with halogens, hydroxides, alcoholates, or organic or inorganic acid anions as counterion; and
d) from 0.1 to 5% by weight of at least one cocatalyst, selected from
   d1) at least one epoxide and/or
   d2) at least one metal acetylacetonate and/or quaternary ammonium acetylacetonate and/or quaternary phosphonium acetylacetonate;
e) optionally auxiliaries and additives known from polyurethane chemistry,
   in such a way that the ratio between the two components hardener and binder is such that there is from 0.3 to 1, preferably from 0.6 to 0.9, uretdione group of the hardener component for every hydroxy group of the binder component. The latter corresponds to an NCO/OH ratio of from 0.6 to 2:1 and, respectively, from 1.2 to 1.8:1.

These highly reactive polyurethane compositions used in the invention are hardened at temperatures of from 100 to 160° C. and are termed variant II. The thermal joining (plastics welding) process can then take place at about 80° C.

In the invention, suitable highly reactive polyurethane compositions comprising uretdione groups comprise mixtures of temporarily deactivated (internally blocked) di- or polyisocyanates which therefore comprise uretdione groups and are also termed hardeners, and of the catalysts present in the invention, and also optionally comprise a polymer (binder) having functional groups—reactive toward NCO groups—also termed resin. The catalysts ensure low-temperature hardening of the polyurethane compositions comprising uretdione groups. The polyurethane compositions comprising uretdione groups are therefore highly reactive.

Binders and hardeners used are components of that type as described above.

Catalysts used are quaternary ammonium salts, preferably tetraalkylammonium salts, and/or quaternary phosphonium salts, with halogens, hydroxides, alcoholates, or organic or inorganic acid anions as counterion. Examples here are:

Tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate and tetrabutylphosphonium acetate, tetrabutylphosphonium formate and ethyltriphenylphosphonium acetate, tetrabutylphosphonium benzotriazolate, tetraphenylphosphonium phenolate and trihexyltetradecyiphosphonium decanoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, methyltributylammonium methanolate, methyltriethylammonium methanolate, tetramethylammonium methanolate, tetraethylammonium methanolate, tetrapropylammonium methanolate, tetrabutylammonium methanolate, tetrapentylammonium methanolate, tetrahexylammonium methanolate, tetraoctylammonium methanolate, tetradecylammonium methanolate, tetradecyltrihexylammonium methanolate, tetraoctadecylammonium methanolate, benzyltrimethylammonium methanolate, benzyltriethylammonium methanolate, trimethylphenylammonium methanolate, triethylmethylammonium methanolate, trimethylvinylammonium methanolate, methyltributylammonium ethanolate, methyltriethylammonium ethanolate, tetramethylammonium ethanolate, tetraethylammonium ethanolate, tetrapropylammonium ethanolate, tetrabutylammonium ethanolate, tetrapentylammonium ethanolate, tetrahexylammonium ethanolate, tetraoctylammonium methanolate, tetradecylammonium ethanolate, tetradecyltrihexylammonium ethanolate, tetraoctadecylammonium ethanolate, benzyltrimethylammonium ethanolate, benzyltriethylammonium ethanolate, trimethylphenylammonium ethanolate, triethylmethylammonium ethanolate, trimethylvinylammonium ethanolate, methyltributylammonium benzylate, methyltriethylammonium benzylate, tetramethylammonium benzylate, tetraethylammonium benzylate, tetrapropylammonium benzylate, tetrabutylammonium benzylate, tetrapentylammonium benzylate, tetrahexylammonium benzylate, tetraoctylammonium benzylate, tetradecylammonium benzylate, tetradecyltrihexylammonium benzylate, tetraoctadecylammonium benzylate, benzyltrimethylammonium benzylate, benzyltriethylammonium benzylate, trimethylphenylammonium benzylate, triethylmethylammonium benzylate, trimethylvinylammonium benzylate, tetramethylammonium fluoride, tetraethylammonium fluoride, tetrabutylammonium fluoride, tetraoctylammonium fluoride, benzyltrimethylammonium fluoride, tetrabutylphosphonium hydroxide, tetrabutylphosphonium fluoride, tetrabutylammonium chloride, tetrabutylammonium bromide, tetrabutylammonium iodide, tetraethylammonium chloride, tetraethylammonium bromide, tetraethylammonium iodide, tetramethylammonium chloride, tetramethylammonium bromide, tetramethylammonium iodide, benzyltrimethylammonium chloride, benzyltriethylammonium chloride, benzyltripropylammonium chloride, benzyltributylammonium chloride, methyltributylammonium chloride, methyltripropylammonium chloride, methyltriethylammonium chloride, methyltriphenylammonium chloride, phenyltrimethylammonium chloride, benzyltrimethylammonium bromide, benzyltriethylammonium bromide, benzyltripropylammonium bromide, benzyltributylammonium bromide, methyltributylammonium bromide, methyltripropylammonium bromide, methyltriethylammonium bromide, methyltriphenylammonium bromide, phenyltrimethylammonium bromide, benzyltrimethylammonium iodide, benzyltriethylammonium iodide, benzyltripropylammonium iodide, benzyltributylammonium iodide, methyltributylammonium iodide, methyltripropylammonium iodide, methyltriethylammonium iodide, methyltriphenylammonium iodide and phenyltrimethylammonium iodide, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethyiphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride, and benzyltrimethylammonium fluoride. These catalysts can be added alone or in mixtures. It is preferable to use tetraethylammonium benzoate and tetrabutylammonium hydroxide.

The proportion of catalysts can be from 0.1 to 5% by weight, preferably from 0.3 to 2% by weight, based on the entire formulation of the matrix material.

One variant of the invention concomitantly includes the linkage of catalysts of this type to the functional groups of the binder polymers. These catalysts can moreover have an inert coating which encapsulates them.

Cocatalysts d1) used are epoxides. It is possible to use the following here by way of example: glycidyl ethers and glycidyl esters, aliphatic epoxides, diglycidyl ethers based on bisphenol A and glycidyl methacrylates. Examples of epoxides of this type are triglycidyl isocyanurate (TGIC, trade name ARALDIT 810, Huntsman), mixtures of diglycidyl terephthalate and triglycidyl trimellitate (trade name ARALDIT PT 910 and 912, Huntsman), glycidyl esters of Versatic acid (trade name KARDURA E10, Shell), 3,4-epoxycyclohexylmethyl 3′,4′-epoxycyclohexanecarboxylate (ECC), diglycidyl ethers based on bisphenol A (trade name EPIKOTE 828, Shell) ethylhexyl glycidyl ether, butyl glycidyl ether, pentaerythritol tetraglycidyl ether, (trade name POLYPOX R 16, UPPC AG), and also other Polypox types having free epoxy groups. It is also possible to use mixtures. It is preferable to use ARALDIT PT 910 and 912.

Cocatalysts d2) that can be used are metal acetylacetonates. Examples here are zinc acetylacetonate, lithium acetylacetonate, and tin acetylacetonate, alone or in mixtures. It is preferable to use zinc acetylacetonate.

Cocatalysts d2) that can also be used are quaternary ammonium acetylacetonates or quaternary phosphonium acetylacetonates.

Examples of catalysts of this type are tetramethylammonium acetylacetonate, tetraethylammonium acetylacetonate, tetrapropylammonium acetylacetonate, tetrabutylammonium acetylacetonate, benzyltrimethylammonium acetylacetonate, benzyltriethylammonium acetylacetonate, tetramethylphosphonium acetylacetonate, tetraethylphosphonium acetylacetonate, tetrapropylphosphonium acetylacetonate, tetrabutylphosphonium acetylacetonate, benzyltrimethylphosphonium acetylacetonate, and benzyltriethylphosphonium acetylacetonate. It is particularly preferable to use tetraethylammonium acetylacetonate and tetrabutylammonium acetylacetonate. It is also possible, of course, to use mixtures of catalysts of this type.

The proportion of cocatalysts d1) and/or d2) can be from 0.1 to 5% by weight, preferably from 0.3 to 2% by weight, based on the entire formulation of the matrix material.

With the aid of the polyurethane compositions used in the invention, which are highly reactive and therefore cure at low temperature, with hardening temperature of from 100 to 160° C., it is possible not only to achieve savings in energy and hardening time but also to use many fibers that are temperature-sensitive.

For the purposes of this invention, highly reactive (variant II) means that the polyurethane compositions used in the invention and comprising uretdione groups harden at temperatures of from 100 to 160° C., where this specifically depends on the nature of the fiber. Said hardening temperature is preferably from 120 to 150° C., particularly preferably from 130 to 140° C. The hardening time for the polyurethane composition used in the invention is within from 5 to 60 minutes.

The highly reactive polyurethane compositions used in the invention and comprising uretdione groups provide very good flow and therefore good impregnation capability, and, in the hardened condition, excellent chemicals resistance. When aliphatic crosslinking agents (e.g. IPDI or H₁₂MDI) are used, good weathering resistance is also achieved.

The reactive or highly reactive polyurethane compositions used as matrix material in the invention consist essentially of a mixture of a reactive resin and of a hardener. Said mixture has, after melt homogenization, a glass transition temperature T₉ of at least 40° C., and reacts generally only above 160° C., in the case of the reactive polyurethane compositions, or above 100° C., in the case of the highly reactive polyurethane compositions, to give a crosslinked polyurethane, thus forming the matrix of the composite. Once the semifinished products of the invention have been produced, they are therefore composed of the fibers and of the reactive polyurethane composition which is in uncrosslinked, but reactive, form and which has been applied as matrix material.

A thermal joining (provisional fixing) process to construct the core structure can then be carried out at about 75 to 82° C. The semifinished products are then storage-stable, generally for a number of days and indeed weeks, and can therefore be further processed at any time to give fiber-composite components. This is the substantial difference from the 2-component systems described above, which are reactive and not storage-stable, since they begin to react to give polyurethanes, and to crosslink, immediately after the application process.

The invention will now be explained in more detail by using embodiments. The figures here show the following:

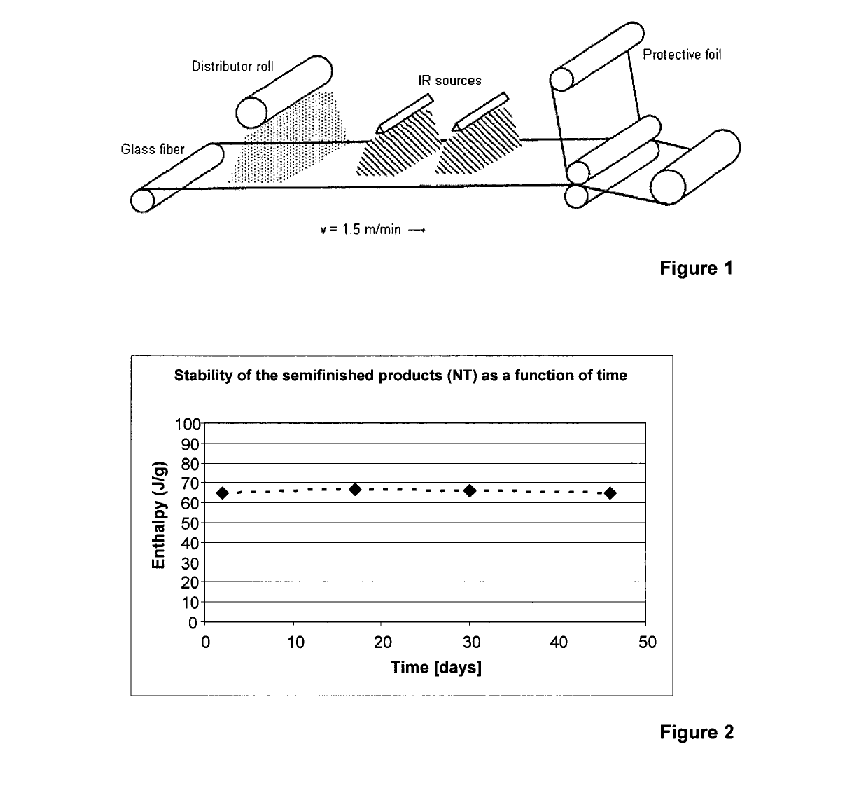

FIG. 1: laboratory distribution device (Villars Minicoater 200) for producing the walls;

FIG. 2: graph of enthalpy plotted against time;

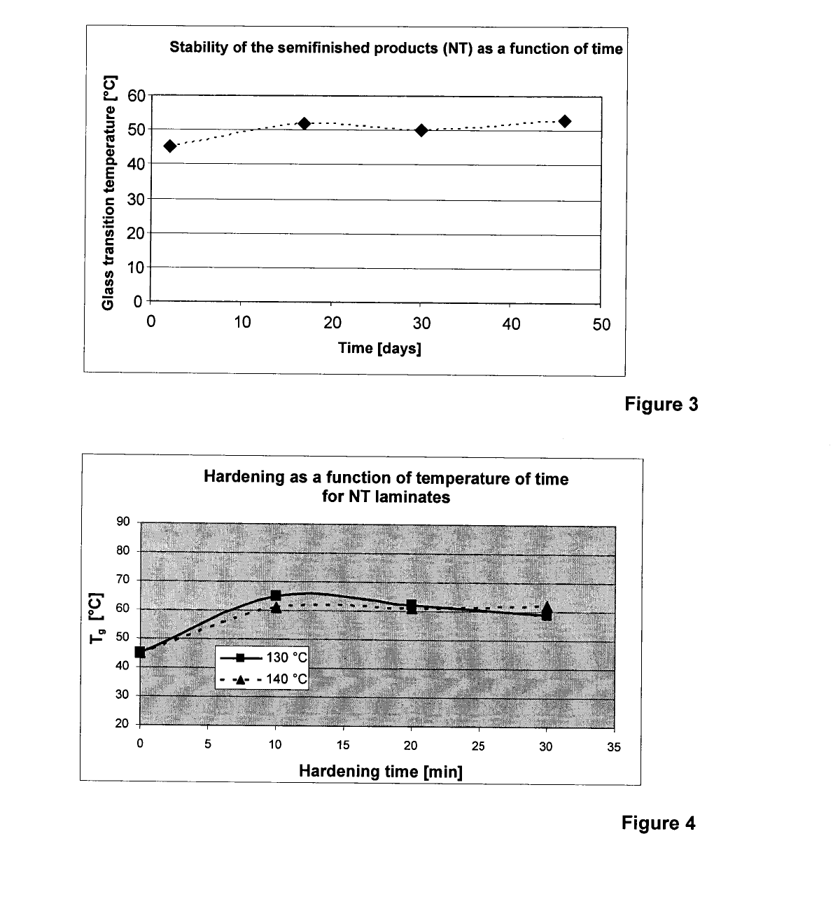

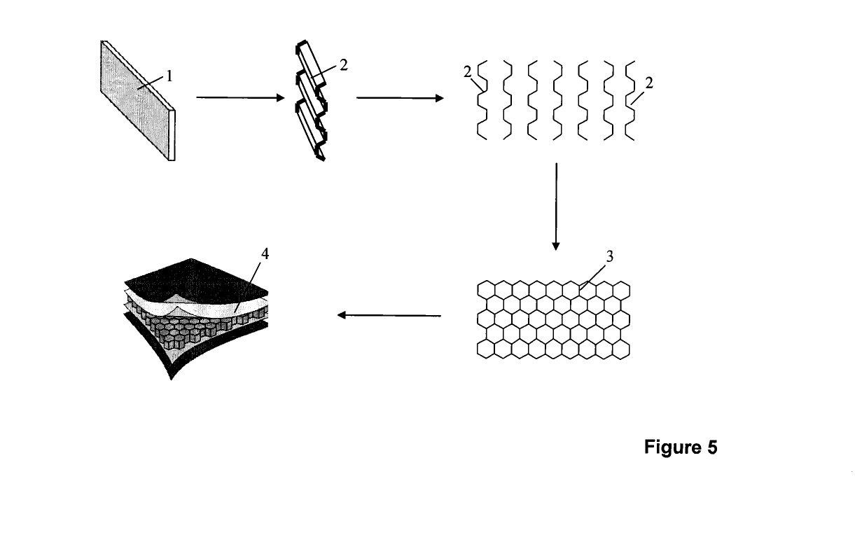

FIGS. 3 and 4: graph of glass transition temperature T₉ plotted against time;

FIG. 5: production of a semifinished product of the invention followed by further processing to give the fiber-composite component (diagrammatic).

### GLASSFIBER LAID SCRIMA/WOVENFABRICS USED

The following glassfiber laid scrims/woven fabrics were used in the examples, hereinafter termed type I and type II.

Type I involves a plain-woven E glass fabric 821 L, product No. 3103 from “Schlösser & Cramer”. The weight per unit area of the woven fabric is 280 g/m². Type II, GBX 600, product No. 1023, involves a stitched biaxial laid scrim of E glass (−45/+45) from “Schlösser & Cramer”. This means two plies of fiber bundles lying on top of one another and displaced at an angle of 90 degrees with respect to one another. This construction is held together by other fibers, which are however not composed of glass. The surface of the glass fibers has been equipped with a standard aminosilane-modified size. The weight per unit area of the laid scrim is 600 g/m².

### DSC Measurements

The DSC studies (glass transition temperature determination and measurement of enthalpy of reaction) were carried out with a Mettler Toledo DSC 821e in accordance with DIN 53765.

### Highly Reactive Pulverulent Polyurethane Composition

A highly reactive pulverulent polyurethane composition with the following formulation was used for producing the walls of the semifinished products.

(Data in % by weight):

| | Formulation of NT |
|---|---|
| Examples | (in the invention) |
| VESTAGON BF 9030 (hardener component a) | 33.04 |
| comprising uretdione groups), Evonik Degussa | |
| FINEPLUS PE 8078 VKRK20 (OH-functional | 63.14 |
| polyester resin component b)), from DIC | |
| BYK 361 N | 0.5 |
| Vestagon SC 5050, | 1.52 |
| (catalyst c) comprising tetraethylammonium | |
| benzoate), Evonik Degussa | |
| Araldit PT 912, (epoxy component d)), | 1.80 |
| Huntsman | |
| NCO:OH ratio | 1.4:1 |

The comminuted starting materials from the table are mixed intimately in a premixer and then homogenized in the extruder up to at most 130° C. After cooling, the extrudate is crushed and milled by a pinned-disk mill. The sieve fractions used had average particle diameters of from 63 to 100 μm.

### Physical Properties

| | NT powder |
|---|---|
| T_{g} [° C.] | about 45 |
| Melting range [° C.] | around 84 |
| Hardening temperature [° C.] | 120-140 |
| Elongation at break of | 9 |
| hardened polyurethane matrix | |
| [%] | |
| Modulus of elasticity of | about 610 |
| hardened polyurethane matrix | |
| [MPa] | |
| Volume shrinkage due to | <0.2% |
| crosslinking | |
| Viscosity minimum of | 111° C./330 |
| uncrosslinked melt | Pa · s |

Selection of suitable sintering conditions during a variety of preliminary experiments showed that the following settings on the minicoater during production of the walls have good suitability:

About 150 g/powder were applied at a web velocity of about 1.2 m/min to a square meter of laid glassfiber scrim. This corresponds to a layer thickness of about 500 μm with a standard deviation of about 45 μm.

With a power rating of 560 W for the IR sources, this method could produce walls in the form of strips at temperatures of from 75 to 82° C., where the highly reactive pulverulent polyurethane composition was incipiently sintered, and it was of no great importance whether the powders were merely incipiently sintered while retaining a discernible powder structure or a full melt was obtained on the glassfiber scrim, as long as the reactivity of the pulverulent polyurethane composition was retained.

### Production of the Core Structure

The flat walls in the form of strips made of fiber-containing matrix material can be further processed as in FIG. 5 to give symmetrical core structures.

For this, the flat wall 1 in the form of a strip is first continuously angled, in each case by 120°, at room temperature, with constant side length, thus obtaining an undulating shape 2 similar to that of sheet metal having trapezoidal corrugations.

A plurality of said angled walls are then arranged in pairs with respect to one another in such a way that their basal side sections are in contact with one another. When the temperature is then in turn raised to from 75 to 82° C., the angled walls 2 are thermally joined to one another by a pressure from rollers, in such a way that the basal side sections of the adjacent walls adhere to one another and thus form a regular, symmetrical hexagonal honeycomb structure 3, the ready-to-use semifinished product.

### Storage-Stability of the Semifinished Products

The storage-stability of the semifinished products was determined by means of DSC studies by using the enthalpies of the crosslinking reaction. FIGS. 2 and 3 show the results.

The crosslinking capability of the semifinished PU products is not impaired by storage at room temperature at least over a period of 7 weeks.

### Production of the Fiber-Composite Component

FIG. 5 shows diagrammatically how a fiber-composite component 4 is produced from the semifinished product 3. The composite component was produced in a composite press by way of press technology known to the person skilled in the art. The honeycomb structure 3 was pressed with outer layers made of the same material in a laboratory press. This laboratory press is the Polystat 200 T from Schwabenthan, and this was used to press the honeycomb structure at from 130 to 140° C. with outer layers made of the same fiber-containing matrix material, to give the corresponding fiber-composite sheets. The pressure was varied between atmospheric pressure and 450 bar. Dynamic pressing procedures, i.e. application of changing pressures, can prove advantageous for the wetting of the fibers as a function of component size, component thickness, and polyurethane composition, and therefore of the viscosity at processing temperature.

In an example, the temperature of the press was kept at 135° C., and the pressure was increased to 440 bar after a melting phase of 3 minutes and was kept at this level until the composite component was removed from the press after 30 minutes.

The resultant hard, stiff, chemicals-resistant, and impact-resistant fiber-composite components 4 with a proportion of >50% of fiber by volume were studied for degree of hardening (determined by way of DSC). Determination of the glass transition temperature of the hardened matrix reveals the progress of crosslinking at different curing temperatures. In the case of the polyurethane composition used, crosslinking is complete after about 25 minutes, whereupon then no further enthalpy can be detected for the crosslinking reaction. FIG. 4 shows the results.

Two composite materials were produced with exactly the same conditions, and properties of these were then determined and compared. This good reproducibility of properties was also confirmed when interlaminar shear strength (ILSS) was determined. The average ILSS achieved here with a proportion of 54 or 57% of fiber by volume was 44 N/mm².

It is also possible for the walls of the semifinished product to assume the undulating shape of embossed sheets, instead of the “traditional” honeycomb structure shown (reference sign 3 in FIG. 5). Embossed sheets are a further development derived from honeycombs and equally serve as core structure for composite components in lightweight construction. In the production of embossed sheets, a multiplicity of polygonal elevations are impressed into flat walls and protrude from the plane. Particularly suitable elevations for the semifinished products of the invention are octagonal and hexagonal. However, quadrilateral and triangular designs are also possible. These have particularly good suitability for use as core of a sandwich.

The elevations are unlike the walls of the traditional honeycomb pattern in that they have undulation in two dimensions, whereas the honeycomb walls have undulation only in one dimension. The embossed sheets are joined to one another in the same way as honeycomb walls, with displacement, thus producing a symmetrical core structure. This novel structure contrasts with the honeycomb cores conventionally used hitherto, in that it provides a large joining area for outer-layer linkage.

Embossed sheets can be used with particular advantage in conjunction with the matrix material described here, since the unhardened polymer composition allows the elevation to be very steep-sided, and thus can give designs which are outside the range that can readily be produced in metal.

Embossed sheets and associated production processes are disclosed inter alia in DE102006031696A1, DE102005026060A1, DE102005021487A1, DE19944662A1, DE10252207B3, DE10241726B3, DE10222495C1 and DE10158276C1. This technology is also applicable to the present matrix materials, to the extent that the above literature describes the forming process in sheet metal processing.

1: A semifinished product, comprising:
a symmetrical core structure having at least two walls which have angled undulations and are made of fiber-filled matrix material, and which have been joined thermally to one another; wherein
the matrix material comprises a polyurethane composition which comprises
c) as binder, a polymer comprising functional groups reactive toward isocyanates, and
d) as hardener, at least one selected from the group consisting of diisocyanate blocked internally, polyisocyanate blocked internally, diisocyanate blocked with blocking agents and polyisocyanate blocked with blocking agents.

2: The semifinished product as claimed in claim 1, further comprising:
at least one outer layer applied to the core structure,
wherein the core structure and the outer layer are joined coherently.

3: The semifinished product as claimed in claim 2, wherein
the outer layer comprises fiber-filled matrix material which comprises a polyurethane composition
a) which comprises, as binder, a polymer comprising functional groups reactive toward isocyanates, and
b) comprises, as hardener, at least one selected from the group consisting of diisocyanate blocked internally, polyisocyanate blocked internally, diisocyanate blocked with blocking agents and polyisocyanate blocked with blocking agents,
and the outer layer and the core structure are joined thermally.

4: A process for producing a semifinished product, comprising:
a) mixing a polyurethane composition comprising,
a binder comprising a polymer comprising functional groups reactive toward isocyanates,
a hardener comprising at least one selected from the group consisting of diisocyanate blocked internally, polyisocyanate blocked internally, diisocyanate blocked with blocking agents and polyisocyanate blocked with blocking agents, and fibers, to obtain a molding composition;
b) molding the molding composition to give a flat wall;
c) subjecting the wall to a forming process in order to give it a shape which has angled undulations;
d) orienting the wall which has angled undulations, in relation to another wall which has angled undulations;
g) thermal joining the two walls to obtain a symmetrical core structure as the semifinished product.

5: The process as claimed in claim 4, further comprising:
h) applying an outer layer to the core structure, wherein the outer layer comprises a fiber-filled matrix material which comprises a polyurethane composition which comprises,
as binder, a polymer having functional groups reactive toward isocyanates and,
as hardener, at least one selected from the group consisting of diisocyanate blocked internally, polyisocyanate blocked internally, diisocyanate blocked with blocking agents and polyisocyanate blocked with blocking agents, and
i) thermal joining of the outer layer to the core structure.

6: The process as claimed in claim 4 wherein
the thermal joining process takes place at a temperature below the hardening temperature of the polyurethane composition.

7: A process for the production of a fiber-composite component, comprising:
a) producing a semifinished product as claimed in claim 4, and
b) hardening of the polyurethane composition at a temperature above the temperature during the thermal joining process.

8: A fiber-composite component comprising the semifinished product as claimed in claim 1.

9: The process as claimed in claim 5, wherein
the thermal joining process takes place at a temperature below the hardening temperature of the polyurethane composition.

10: A process for the production of a fiber-composite component, comprising:
a) producing a semifinished product as claimed in claim 5, and
b) hardening of the polyurethane composition at a temperature above the temperature during the thermal joining process.

11: A process for the production of a fiber-composite component, comprising:
a) producing a semifinished product as claimed in claim 6, and
b) hardening of the polyurethane composition at a temperature above the temperature during the thermal joining process.

12: A fiber-composite component comprising the semifinished product as claimed in claim 2.

13: A fiber-composite component comprising the semifinished product as claimed in claim 3.

14: A fiber-composite component obtained by process as claimed in claim 7.
